(19) United States
(12) Patent Application Publication
(10) Pub. No.: US 2019/0039157 A1
(43) Pub. Date: Feb. 7, 2019

(54) SUPPORT ACCESSORY FOR PORTABLE TOOL STANDS AND METHOD

(71) Applicant: Jeremy James Hanrahan, Knutsford (CA)

(72) Inventor: Jeremy James Hanrahan, Knutsford (CA)

(21) Appl. No.: 15/665,729

(22) Filed: Aug. 1, 2017

(51) Int. Cl. B23D 47/02; B23D 51/02

(52) U.S. Cl. CPC B23D 47/025; B27C 9/04; B23D 51/02

(57) ABSTRACT

An accessory device for a portable tool stand, the accessory device including a storage box configured to store user items adjacent a portable tool of the portable tool stand, the storage box. The storage box is designed to freely pivot between a folded position and at least one deployed position, the at least one deployed position defining at least one storage space for user items to be stored. The system includes a releasable lock configured to releasably lock the storage box in the deployed position, and at least one mounting device configured to removably mount the storage box to the portable tool stand.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of woodworking and cutting tools of existing art and more specifically relates to woodworking and cutting with means to support work relative to the tool(s).

### RELATED ART

There are many applications for portable saws at construction sites, in workshops, and in fabrication shops. For example, contractors often transport such apparatus to a job site to use during construction. Often, the portable saws, and similar devices, are secured to a portable base stand or similar temporary elevated support.

Despite the many advantages these portable supports have, they are limited in their ability to handle large workpieces. Usually, the support ends are only a few inches square, providing minimal support of the stock as it is being cut. As one example, portable miter saws are often used to cut interior and exterior trim, which often have lengths exceeding eight feet. Without proper support, it is difficult for one person to cut such large pieces of wood. To address this limitation, some portable support bases have pull-out extensions that attempt to increase the support capacity of the saw assembly. Although these help, they are often limited in their useful support capability. Users frequently try to make do with the limited support offered by conventional stands, often leading to compromised safety and results. Additional work-surface areas would be of great benefit to users attempting to modify panels or long pieces, during planing, trimming, and sanding to perfect the fit of the finished items.

Another problem associated with such portable saws and mobile base supports is their lack of storage. For example, conventional miter-saw stands have a saw and small supports with nothing in between but a narrow rail. In the interest of portability, such apparatus omit storage features, requiring a user to inconveniently store tools and other work-related items on the ground surface adjacent the portable support stand. In light of these limitations, a need clearly exists for new systems and methods to overcome these limitations.

Prior attempts have been made to address the above-noted problems. By way of example, U.S. Publication No. 2010/0051137 to Layton relates to a portable workbench. The described portable workbench includes workbench assembly including: a sawhorse, a mounting bracket, a planar member, and a power outlet. The sawhorse includes: a track, and a pair of support legs extending downwardly from the track. The mounting bracket is configured to releasably couple to the track of the sawhorse. The planar member, having a primary plane, is coupled to the mounting bracket and configured to provide a tabletop when the mounting bracket is coupled to the track such that the primary plane tapers at a tapered end. The power outlet is coupled to the planar member. The usefulness of the Layton device is limited in that apparatus is bulky and restricted in its ability to be compactly stowed and transported.

### SUMMARY OF THE INVENTION

In view of the foregoing disadvantages inherent in the known art of woodworking and cutting applications with means to support work relative to the tool(s), the present disclosure provides a novel support accessory for portable tool stands and method. The general purpose of the present disclosure, which will be described subsequently in greater detail, is to provide a support accessory for portable work stands and method.

An accessory device is disclosed herein. The accessory device includes an accessory device for portable tool stands, such as a miter-saw stand or similar mobile support devices. The accessory device includes a storage box configured to store user items adjacent a miter saw of the portable tool stand, the storage box including a top member configured to support a workpiece during operation of the portable tool, a base member configured to support the user items stored within the storage box, a set of end walls, each end wall of the set of end walls pivotally connected to the top member and the base member, the set of end walls configured to enable the storage box to freely pivot between a folded position and at least one deployed position, the at least one deployed position defining at least one storage space for the user items located between the top member, the base member, and the set of end walls, at least one releasable lock configured to releasably lock the storage box in the deployed position, and at least one mounting device configured to removably mount the storage box to the portable tool stand. Moreover, it provides such an accessory device further including set of instructions; and wherein the accessory device is arranged as a kit.

According to another embodiment, a method of use related to an accessory support and storage device removably mountable on a miter-saw stand, or similar portable support, is also disclosed herein. The method of use includes the steps of: providing a storage box configured to store user items adjacent a portable tool of the portable tool stand, the storage box including at least one mounting adapter configured to enable the interchangeable mounting of at least one mounting device functionally compatible with at least one proprietary mounting system of the portable tool stand; providing at least one mounting device functionally compatible with at least one proprietary mounting system of the portable tool stand; mounting the at least one mounting device to the storage box; and mounting the storage box to the portable tool stand. Additionally, it provides such a method of use, further including the step of configuring the storage box to be adjustable between a folded position and at least one deployed position, the at least one deployed position defining at least one storage space for the storage of user items.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a support accessory for portable tool stand and method, constructed and operative according to the teachings of the present disclosure.

FIG. 1 is a perspective view of the accessory device during an ‘in-use’ condition, according to an embodiment of the disclosure.

FIG. 2 is a perspective view of the accessory device of FIG. 1, according to an embodiment of the present disclosure.

FIG. 3 is a front view of the accessory device of FIG. 1, according to an embodiment of the present disclosure.

FIG. 4 is a front view of the accessory device of FIG. 1, enlarged for clarity of description, according to an embodiment of the present disclosure.

FIG. 5 is an exploded perspective view of the accessory device of FIG. 1, according to an embodiment of the present disclosure.

FIG. 6 is another exploded perspective view of the accessory device of FIG. 1, according to an embodiment of the present disclosure.

FIG. 7 is a sectional view of the accessory device of FIG. 1, taken through the section 7-7 of FIG. 2, according to an embodiment of the present disclosure.

FIG. 8 is the detail view 8 of FIG. 7, enlarged for clarity, of the accessory device of FIG. 1, according to an embodiment of the present disclosure.

FIG. 9 is the detail view 9 of FIG. 7, enlarged for clarity, of the accessory device of FIG. 1, according to an embodiment of the present disclosure.

FIG. 10 is a side view of the accessory device of FIG. 1, shown in a partially folded configuration, according to an embodiment of the present disclosure.

FIG. 11 is a side view of the accessory device of FIG. 1, shown in a fully folded configuration, according to an embodiment of the present disclosure.

FIG. 12 is a sectional view of the accessory device of FIG. 1, taken through the section 12-12 of FIG. 11, according to an embodiment of the present disclosure.

FIG. 13 is a perspective view of an alternate releasable lock of the accessory device of FIG. 1, according to an embodiment of the disclosure.

FIG. 14 is a flow diagram illustrating a method of use for improving functionality of portable tool stands, according to an embodiment of the present disclosure.

FIG. 15 is a front view of an alternate secondary supportive mounting device of the accessory device of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to woodworking and cutting with means to support work relative to the tool(s) and more particularly to a support accessory for mobile work stands, such as portable miter-saw stands, and method as used to improve the support and storage functionality of such stands.

Generally, the present system provides a support accessory for portable saw stands, and similar mobile work stands. The apparatus of the present disclosure attach to commercially-available proprietary quick release clamping systems used with, for example, miter-saw stands and can be fitted to most commercially-available portable tool stands and clamps.

Users frequently try to make do with the limited support offered by conventional stands, often leading to compromised safety and results (i.e., holding a small workpiece across the narrow rail of the portable work stand while trimming with a jig saw, instead of clamping it to a proper surface). The system provides additional safety via increased work-surface areas that are highly useful when modifying panels or long pieces, during planing, trimming, and belt sanding to perfect the fit of the finished items. The disclosed apparatus creates a large stable platform with storage underneath. The device greatly improves workpiece support during use. The apparatus disclosed herein are both modular and lightweight. The disclosed apparatus provides a large platform and storage underneath the platform for off cuts, a jig saw, safety glasses etc.

The accessory provides a go-to workstation for such modifications without the need for additional work surfaces. Although the terms saw stand and miter-saw stand are used herein, it should be understood that presently-disclosed accessory may be used with a wide range of tools, including but not limited to planers, sanders, drills, cutting lists, chisels, squares, measuring tapes, etc.

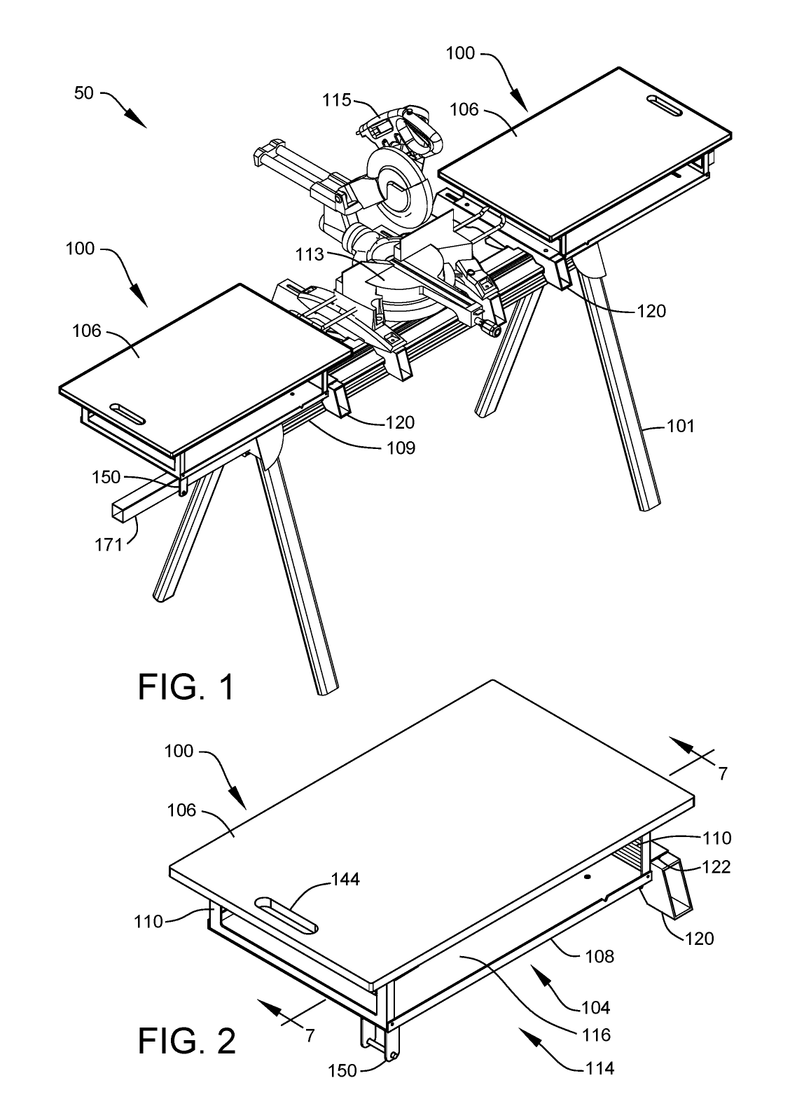

Referring now more specifically to the drawings by numerals of reference, there is shown in FIGS. 1-15, various views of an accessory device 100.

FIG. 1 shows an accessory device 100 during an ‘in-use’ condition 50, according to an embodiment of the present disclosure. FIG. 2 is a perspective view of the accessory device 100 of FIG. 1, according to an embodiment of the present disclosure. Here, the accessory device 100 may be beneficial for use by a user to modify an existing portable tool stand 101 to provide additional support and storage. As illustrated, the accessory device 100 may include an open storage box 104 configured to store user items 103 adjacent a miter saw 115 (or other tool) mounted to the portable tool stand 101, as shown. Although two accessory devices 100 are shown during the ‘in-use’ condition 50 of FIG. 1, a single device may be used if multiple units are not required or preferred. It is noted that the disclosed accessory device may be adapted for use with similar support devices designed for other power tools, or similar portable-support devices.

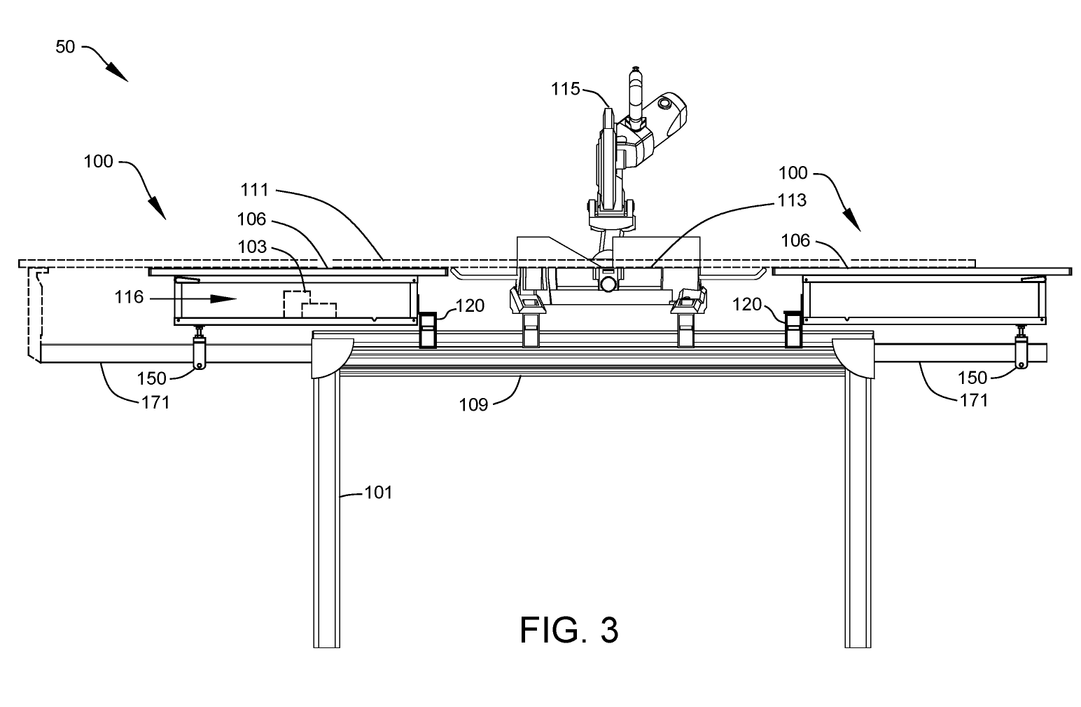

FIG. 3 is a front view of the accessory device 100 during the ‘in-use’ condition 50 of FIG. 1. In reference to FIG. 1 through FIG. 3, the storage box 104 may include a top member 106, a base member 108, and an opposing set of end walls 110, as shown. Each end wall 110 of the set of end walls 110 is pivotally connected to the top member 106 and the base member 108. This pivotal arrangement allows the storage box 104 of the accessory device 100 to freely pivot between a deployed position 114 (see FIG. 2) and a folded position 112 (see FIG. 11). When assembled, the top member 106 of the device provides an accessory support surface for a workpiece 111 during operation of the miter saw 115 (see FIG. 3). In addition, the base member 108 is configured to support user items 103 stored within the storage box 104. The deployed position 114 defines a storage space 116 for the user items 103 located between the top member 106, the base member 108, and the set of end walls 110.

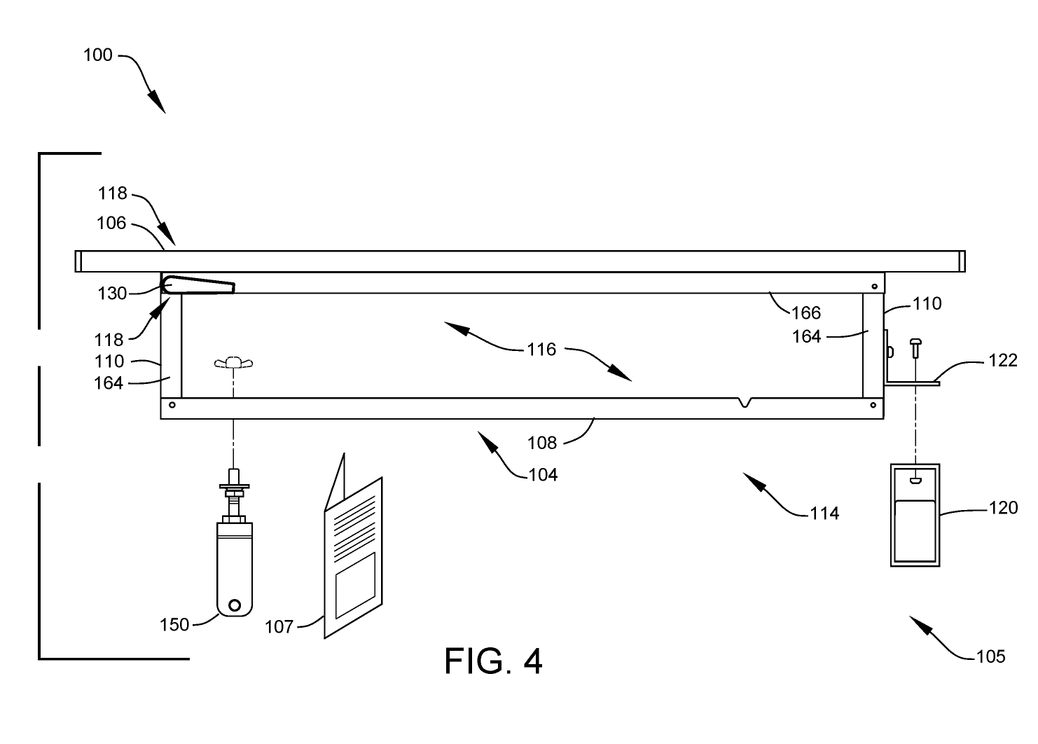

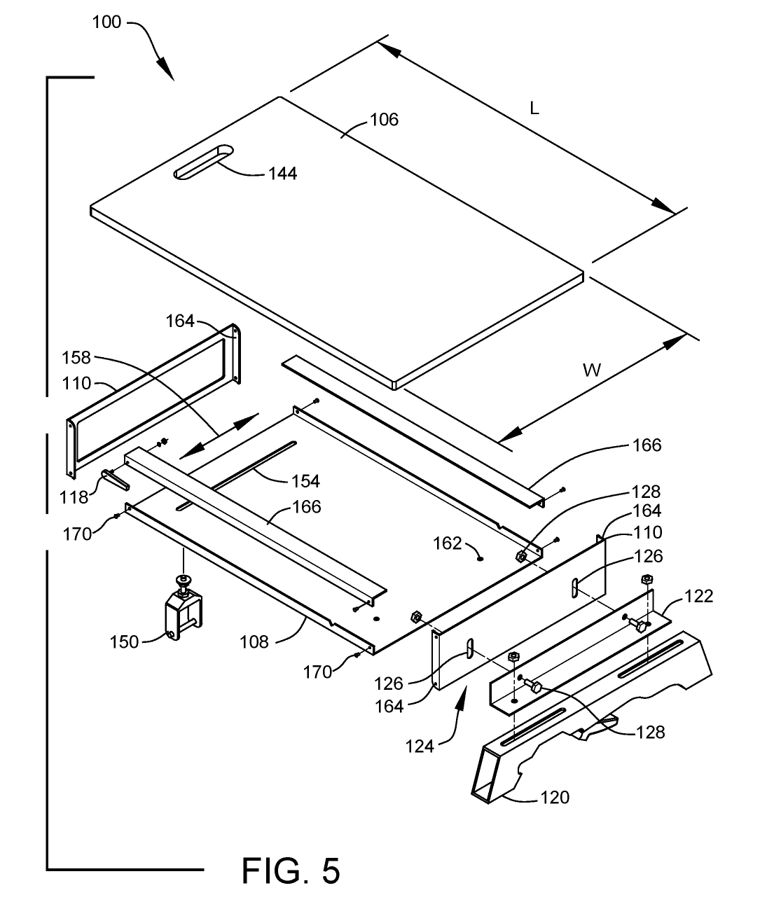

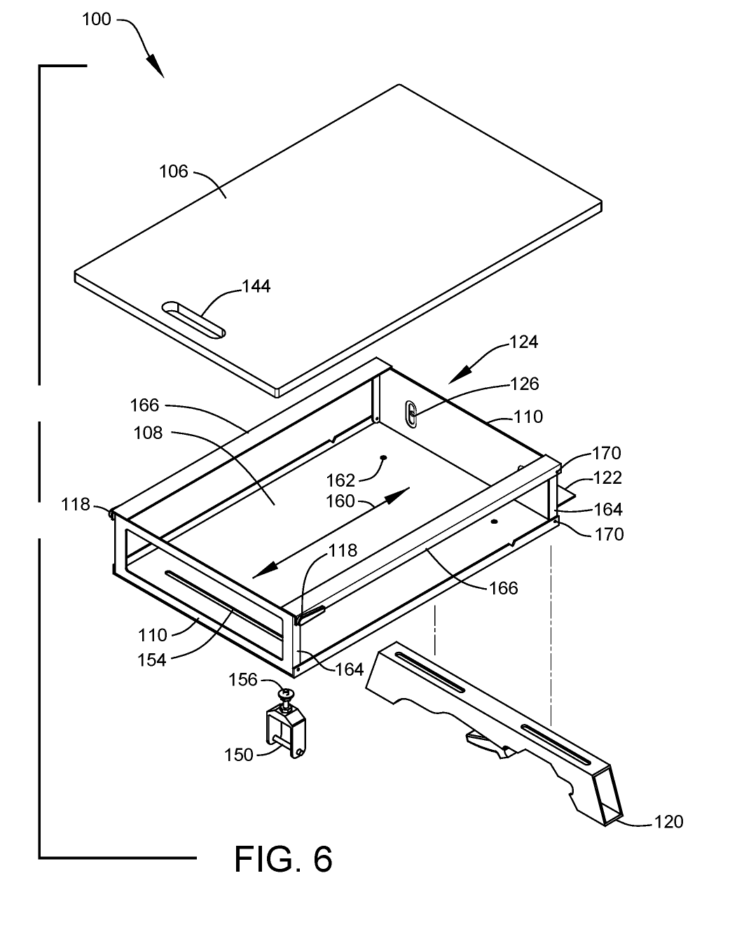

FIG. 4 is a front view of the accessory device 100 of FIG. 1, enlarged for clarity of description. FIG. 5 is an exploded perspective view of the accessory device 100 of FIG. 1, according to an embodiment of the present disclosure. FIG. 6 is another exploded perspective view of the accessory device 100 of FIG. 1. FIG. 4 through FIG. 6 illustrate a set of sub-components that form the accessory device 100 when assembled. Visible in the exploded views of FIG. 4 through FIG. 6 are the top member 106, the base member 108, and the set of end walls 110.

The accessory device 100 is designed to utilize one or more quick-release mounting devices 120 configured to allow the mount the accessory device 100 to be quickly coupled to and decoupled from the portable tool stand 101. Such mounting devices 120 are configured to be functionally compatible with one or more proprietary mounting systems of the selected portable tool stand 101. For example, the mounting device 120 may be a design compatible with a model DW7251 commercially-available mounting bracket produced by the DEWALT Company of Baltimore, Md. Alternately, the accessory device 100 may directly utilize such a quick-release portable tool mounting brackets as produced and supplied by the manufacturer of the portable tool stand 101 (i.e., a proprietary mounting system of the portable tool stand 101). In the depicted example, the mounting devices 120 are configured to engage a linear support beam 109 of the portable tool stand 101 (see again FIG. 1). By way of example, one portable tool stand 101 suitable for use with the present disclosed device are models DW723/DW724 produced by the DEWALT Company, as noted above. Upon reading this specification, it should be appreciated that, under appropriate circumstances, considering such issues as user preferences, design preference, structural requirements, marketing preferences, cost, available materials, technological advances, etc., other saw stand and mounting arrangements such as, for example, the use of alternate portable tool stand models, the use of alternate brands, providing proprietary portable tool-support stand, using the device with other power tools such as grinders, planers, sanders, drills, etc., may be sufficient. Furthermore, those of ordinary skill in the art will appreciate, on reading this specification, that the disclosed accessory may be highly useful in supporting the operation of other woodworking tools. For example, a planer could be attached by quick release clamps at a 90-degree angle to the length of the stand, allowing the accessories to serve as in-feed/off-feed tables.

A mounting adapter 122 is provided to enable the interchangeable mounting of the mounting device 120 to the storage box 104 of the accessory device 100. The mounting adapter 122 may be formed from a rigid angle member having a one leg joined to an end wall 110 of the storage box 104 and a second leg projecting outwardly to engage the mounting device 120, as shown. The mounting adapter 122 may be fastened to the end wall 110 using a set of user-securable threaded fastener 128, as shown. The mounting adapter 122 may include a vertical adjuster 124 to enable vertical adjustment of the position of the mounting adapter 122 relative to the end wall 110 and to the portable tool stand 101. Thus, the user may adjust the elevation of top member 106 to match an elevation of the table 113 of the miter saw 115 (see also FIG. 3). In one version of the device, the vertical adjuster 124 is formed by a set of vertically oriented slots 126 located in the end wall 110, each one adapted to receive the user-securable threaded fastener 128, as shown in FIG. 5.

The top member 106 may include at least one hand opening 144 to assist manual grasping of the accessory device 100. Even further, the base member 108 may include one or more drainage holes 162. The drainage holes 162 can be strategically located to allow a long driver bit to pass through, for ease of fastening of the replaceable top member 106 by way of screws through the underside of the angle bracket. In one version of the accessory device 100, the top member 106 has a width W of about 20 inches and a length L of about 32 inches (see FIG. 5). Upon reading this specification, it should be appreciated that, under appropriate circumstances, considering such issues as user preferences, design preference, structural requirements, marketing preferences, cost, available materials, technological advances, etc., other size arrangements such as, for example, larger or smaller assemblies, etc., may be sufficient.

The accessory device 100, may further include a secondary supportive mounting device 150 configured to supportively mount the base member 108 to an extendable support rail 171 of the portable tool stand 101 (see also FIG. 3). The base member 108 includes a receiving slot 154 configured receive a threaded shaft 156 of the secondary supportive mounting device 150, as shown. The receiving slot 154 is adapted to enable transverse adjustment to the position of secondary supportive mounting device 150 relative to the storage box 104 along a transverse axis 158 generally perpendicular to a longitudinal axis 160 of the portable tool stand (see FIG. 5 and FIG. 6). A flange nut and lock nut are adjustably engaged on the threaded shaft 156 to allow the user to set the height of the accessory device 100 relative to the support beam 109 (see again FIG. 3). An optional wing nut, or similar threaded fastener (see FIG. 4), may be provided to secure the threaded shaft 156 of the secondary supportive mounting device 150 within the receiving slot 154. The secondary supportive mounting device 150 allows the accessory device 100 to be moved away from the miter saw 115 to assist in supporting a workpiece 111 having an extended length. The secondary supportive mounting device 150 may consist of a commercially available square clamp and bolt, as shown. FIG. 15 is a front view showing an alternate secondary supportive mounting device 151 of the accessory device 100, according to an embodiment of the present disclosure. The configuration of the alternate secondary supportive mounting device 151 is substantially similar to the above-described secondary supportive mounting device 150; however, the alternate secondary supportive mounting device 151 utilizes a lever-tightened set screw 153 rather than the retaining bolt of the previous support. The alternate quick-release set screw 153 allows for quick and installation and removal of the alternate secondary supportive mounting device 151, which increases convenience and practicality of the system.

At least one releasable lock 118 is provided to lock the storage box 104 in the deployed position 114 of FIG. 4. In one version of the device, the releasable lock 118 consists of a set of user-operable levers 130, as shown in FIG. 4 and FIG. 5. Each of the user-operable levers 130 may include a threaded shaft passing through a set of aligned apertures located within a side flange 164 of the end wall 110 and an angle bracket 166 of the top member 106. The projecting end of the threaded shaft engages threaded component, such as a hex nut, allowing the locking assembly to be tightened and untightened when the user-operable lever 130 is rotated. The releasable lock 118 is adapted to frictionally constrain the top member 106 and the end wall 110 in a fixed relationship when tightened. During use, the user-operable levers 130 swing up, tightening the components together, thereby locking the accessory device 100 in either the deployed or folded configuration. Upon reading this specification, it should be appreciated that, under appropriate circumstances, considering such issues as user preferences, design preference, structural requirements, marketing preferences, cost, available materials, technological advances, etc., other locking arrangements such as, for example, lever-operated quick-release cam-type clamps, spring-loaded pull pins, etc., may be sufficient.

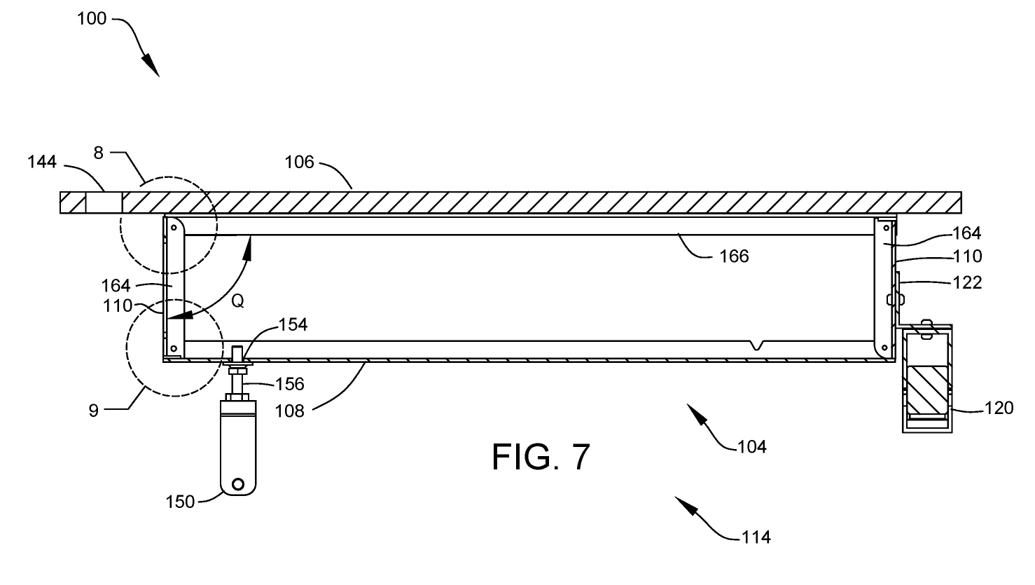

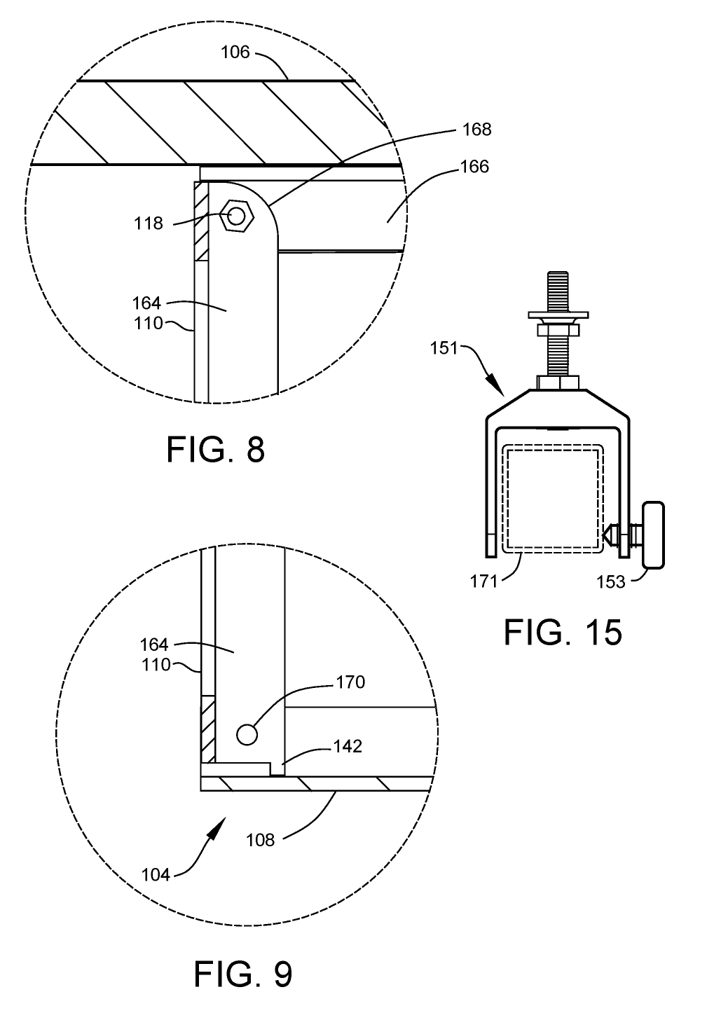

FIG. 7 is a sectional view of the accessory device 100 of FIG. 1, taken through the section 7-7 of FIG. 2, according to an embodiment of the present disclosure. FIG. 8 is the detail view 8 of FIG. 7, enlarged for clarity, of the accessory device 100. FIG. 9 is the detail view 9 of FIG. 7, enlarged for clarity, of the accessory device of FIG. 1, according to an embodiment of the present disclosure. Referring to FIG. 7 through FIG. 9, when the storage box 104 is arranged in the deployed position 114 of FIG. 7, the set of end walls 110 are arranged at about a 90-degree orientation Q relative to the top member 106 and the base member 108. Each side flange 164 of the end walls 110 may include a 90-degree positive stop 142 (see FIG. 9) to prevent the set of end walls 110 from pivoting past the 90-degree orientation as the storage box 104 is pivoted between the folded position 112 and the deployed position 114. The opposing end of each side flange 164 may include a radius 168 to allow the side flange 164 to clear the adjacent members as storage box 104 is pivoted between the folded position 112 and the deployed position 114. With the exception of the tightening points noted above, each side flange 164 is pivotally joined to the angle bracket 166 and base member 108 with rivets 170, as shown. Upon reading this specification, it should be appreciated that, under appropriate circumstances, considering such issues as user preferences, design preference, structural requirements, marketing preferences, cost, available materials, technological advances, etc., other pivot attachment arrangements such as, for example, bolts and nut, integral shafts, etc., may be sufficient.

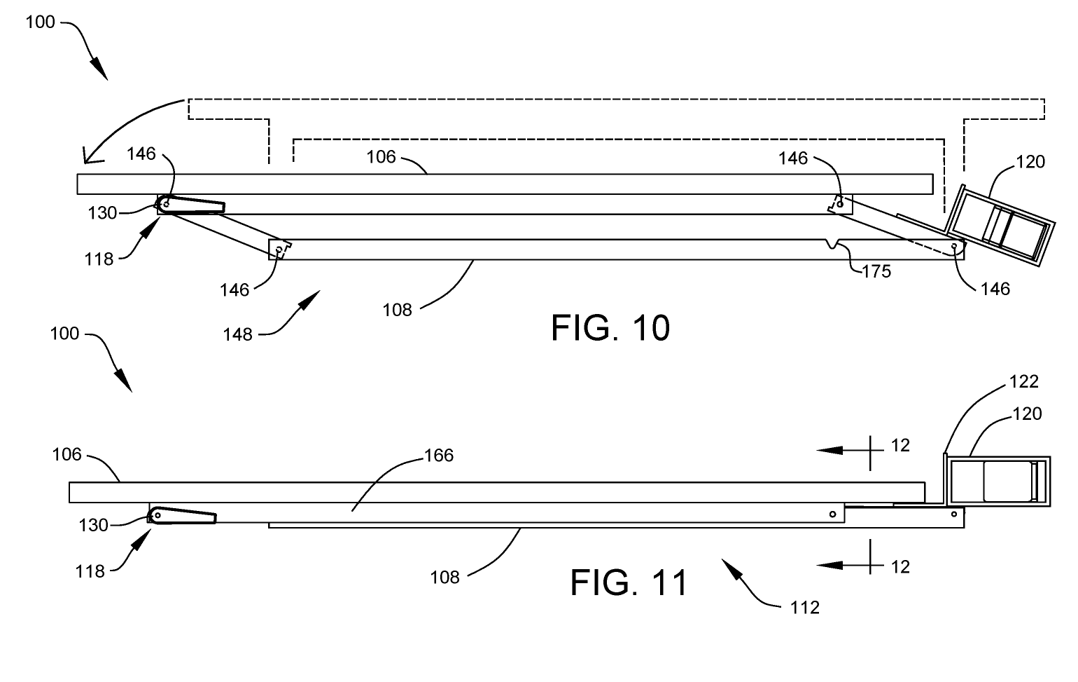

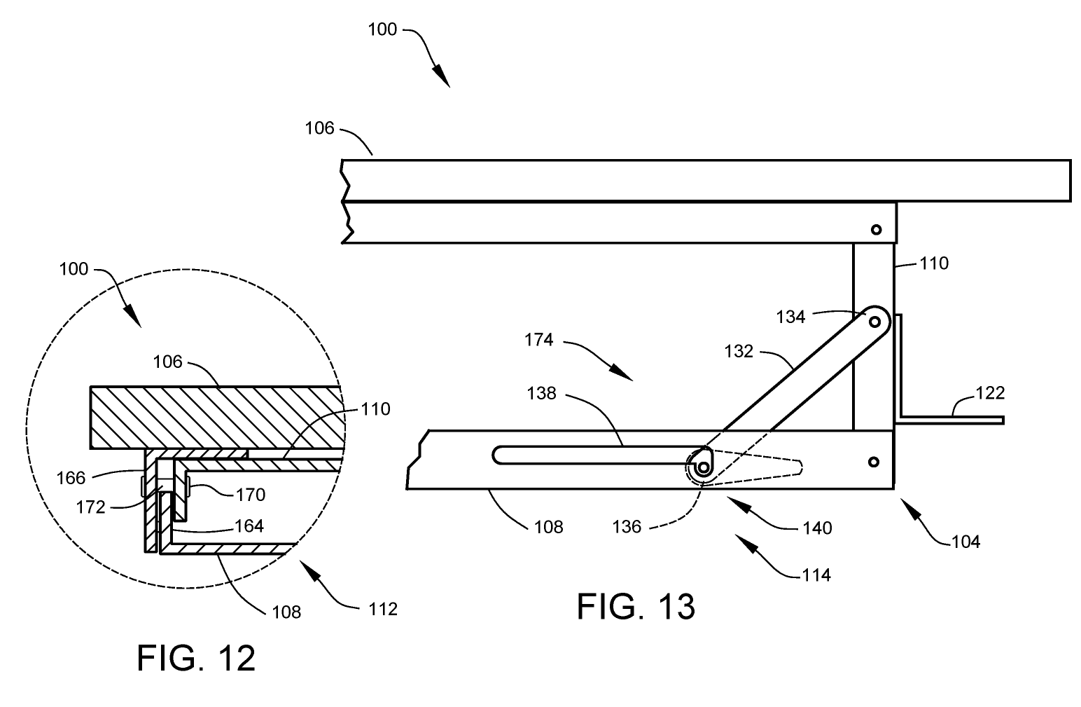

FIG. 10 is a side view of the accessory device 100 of FIG. 1, shown in a partially folded configuration, according to an embodiment of the present disclosure. FIG. 11 is a side view of the accessory device 100 of FIG. 1, shown in a fully folded configuration 112, according to an embodiment of the present disclosure. FIG. 12 is a sectional view of the accessory device 100 of FIG. 1, taken through the section 12-12 of FIG. 11, according to an embodiment of the present disclosure. The top member 106, the base member 108, and the set of end walls 110 pivot about four pivotal axes 146 that form an articulated parallelogram 148. To allow the accessory device 100 to fold fully flat, the horizontal alignments of the side flange 164, the angle bracket 166, and base member 108 are arranged to allow the components to form the nested arrangement shown. A spacer 172 may be used to locate the vertical leg of the angle bracket 166 outside both the side flange 164 and the vertical leg of the base member 108, as shown. A shallow notch 175 may also be included in the vertical leg of the base member 108 to accommodate the spacer 172 when the accessory device 100 is in the fully folded position 112, thus allowing the assembly to fold fully flat, as shown. When in the folded position 112, the unit may be transported or stored in an upright position with the hand opening 144 located toward the top and the mounting device 120 used to rest the device on a ground surface. Two of the devices may be transported or stored top to top.

FIG. 13 is a perspective view of an alternate releasable lock 174 of the accessory device 100 of FIG. 1, according to an embodiment of the disclosure. The alternate releasable lock 174 utilizes a diagonal brace with a brace-end lock 140 (i.e., tightening knob) at an elongated slot 138, as shown. The brace-end lock 140 is used to fix the assembly at 90 degrees for use and also fixes the assembly in the folded position 112 for transport. More specifically, the diagonal brace 132 may have a first end 134 pivotally mounted to one of the end walls 110 and a second end 136 slidably mounted within the elongated slot 138 of the base member 108, as shown. The brace-end lock 140 is provided to lock the second end 136 at a user-selected position within the elongated slot 138.

In at least one embodiment of the disclosed device, the base member 108, the set of end walls 110, and the upper angle brackets 166 are constructed from at least one rigid metallic material. Preferred metallic materials may include aluminum. The top member 106 may be constructed from a rigid non-metallic material. Preferred non-metallic materials may include plywood. Alternately, one or more of the above-noted components of the device may be constructed from a plastic material. The upper angle brackets 166 may be mechanically fastened to the underside of the top member 106 using bolts or screws.

According to one embodiment, the accessory device 100 may be arranged as a kit 105, as shown in FIG. 4. In particular, the accessory device 100 may further include a set of instructions 107. The instructions 107 may detail functional relationships in relation to the structure of the accessory device 100 such that the accessory device 100 can be used, maintained, or the like, in a preferred manner.

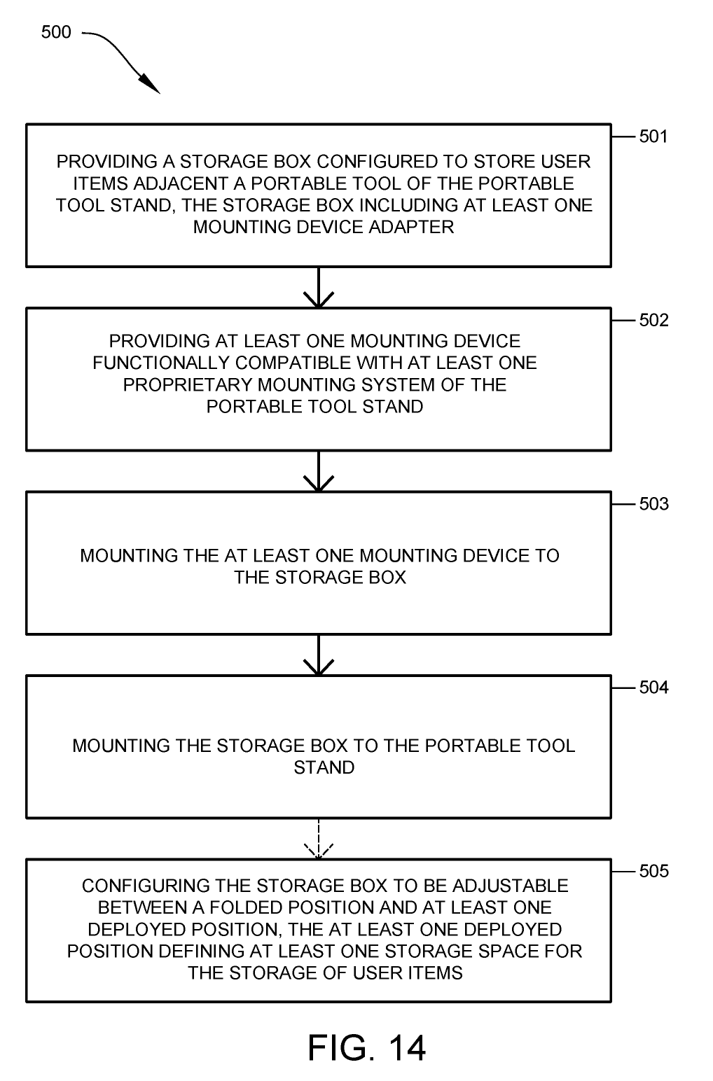

FIG. 14 is a flow diagram illustrating a method of use 500 related to an accessory support and storage device removably mountable on a miter-saw stand or similar portable support device, according to an embodiment of the present disclosure. In particular, the method of use 500 may include one or more components or features of the accessory device 100 as described above. As illustrated, the method 500 may include the steps of: step one 501, providing a storage box configured to store user items adjacent a portable tool of the portable tool stand, the storage box including at least one mounting device adapter configured to enable the interchangeable mounting of at least one mounting device functionally compatible with at least one proprietary mounting system of the portable tool stand; step two 502, providing at least one mounting device functionally compatible with at least one proprietary mounting system of the portable tool stand; step three 503, mounting the at least one mounting device to the storage box; and step four 504, mounting the storage box to the portable tool stand.

Even further, it provides such a method of use 500, further comprising the step five 505 of configuring the storage box to be adjustable between a folded position and at least one deployed position, the at least one deployed position defining at least one storage space for the storage of user items.

It should be noted that step 505 is an optional step and may not be implemented in all cases. Optional steps of method of use 500 are illustrated using dotted lines in FIG. 14 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for functionality of portable tool stands [NOTE: e.g., different step orders within above-mentioned list, elimination or addition of certain steps, including or excluding certain maintenance steps, etc.], are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An accessory device for a portable tool stand, the accessory device comprising:
a storage box configured to store user items adjacent a portable tool of the portable tool stand, the storage box including
a top member configured to support a workpiece during operation of the portable tool,
a base member configured to support the user items stored within the storage box,
a set of end walls, each end wall of the set of end walls pivotally connected to the top member and the base member, the set of end walls configured to enable the storage box to freely pivot between a folded position and at least one deployed position, the at least one deployed position defining at least one storage space for the user items located between the top member, the base member, and the set of end walls,
at least one releasable lock configured to releasably lock the storage box in the deployed position, and
at least one mounting device configured to removably mount the storage box to the portable tool stand.

2. The accessory device of claim 1, wherein the at least one mounting device is configured to be functionally compatible with at least one proprietary mounting system of the portable tool stand.

3. The accessory device of claim 1, further comprising a mounting adapter configured to enable the interchangeable mounting of the at least one mounting device to the storage box.

4. The accessory device of claim 3, wherein at least one of the end walls of the storage box includes at least one of the mounting adapters.

5. The accessory device of claim 3, wherein the mounting adapter comprises a vertical adjuster to enable vertical adjustment of the elevation of top member relative to the portable tool stand to match an elevation of a table of the portable tool.

6. The accessory device of claim 5, wherein the vertical adjuster comprises a set of vertically oriented slots formed within at least one of the end walls, each vertically oriented slot adapted to receive a user-securable threaded fastener adapted to adjustably secure the mounting adapter to such at least one of the end walls.

7. The accessory device of claim 3, wherein the at least one mounting device comprises a proprietary mounting system of the portable tool stand.

8. The accessory device of claim 1, wherein
the base member and the set of end walls are constructed from at least one rigid metallic material; and
the top member is constructed from a rigid non-metallic material.

9. The accessory device of claim 1, wherein the at least one releasable lock comprises a user-operable friction lever adapted to frictionally constrain the top member and at least one end wall of the set of end walls in a fixed relationship.

10. The accessory device of claim 1, wherein the at least one releasable lock comprises:
a diagonal brace having a first end pivotally mounted to one of the end walls and a second end slidably mounted within an elongated slot of the base member; and
a brace-end lock configured to lock the second end at a user-selected position within the elongated slot.

11. The accessory device of claim 1, wherein
the set of end walls comprise a 90-degree orientation relative to the top member and the base member when the storage box is arranged in the at least one deployed position; and
the end walls includes a 90-degree positive stop to prevent the set of end walls from pivoting past the 90-degree orientation as the storage box is pivoted between the folded position and at least one deployed position.

12. The accessory device of claim 1, wherein the top member has at least one hand opening to assist manual grasping of the storage box.

13. The accessory device of claim 1, wherein the top member, the base member, and the set of end walls pivot about four pivotal axes that form an articulated parallelogram.

14. The accessory device of claim 1, further comprising:
at least one secondary supportive mount configured to supportively mount the base member to a support rail of the portable tool stand;
wherein the base member comprises a receiving slot configured receive a threaded shaft of the second supportive mount, the receiving slot adapted to enable transverse adjustment to the position of the storage box along an axis generally perpendicular to a longitudinal axis of the portable tool stand.

15. The accessory device of claim 1, wherein the base member comprises at least one drainage hole adapted to drain water from the base member, the at least one drainage hole situated to allow for the passage of a tool to assist mechanical fastening of the top member to the storage box.

16. The accessory device of claim 1, wherein the top member has a width of about 20 inches and a length of about 32 inches.

17. An accessory device for a portable tool stand, the accessory device comprising:
a storage box configured to store user items adjacent a portable tool of the portable tool stand, the storage box including
a top member configured to support a workpiece during operation of the portable tool,
a base member configured to support the user items stored within the storage box,
a set of end walls, each end wall of the set of end walls pivotally connected to the top member and the base member, the set of end walls configured to enable the storage box to freely pivot between a folded position and at least one deployed position, the at least one deployed position defining at least one storage space for the user items located between the top member, the base member, and the set of end walls,
at least one releasable lock configured to releasably lock the storage box in the deployed position,
at least one mounting device configured to removably mount the storage box to the portable tool stand,
a mounting adapter configured to enable the interchangeable mounting of the at least one mounting device to the storage box, and
at least one secondary supportive mount configured to supportively mount the base member to a support rail of the portable tool stand;
wherein the at least one mounting device is configured to be functionally compatible with at least one proprietary mounting system of the portable tool stand;
wherein at least one of the end walls of the storage box include at least one of the mounting adapters;
wherein the mounting adapter comprises a vertical adjuster to enable vertical adjustment of the elevation of top member relative to the portable tool stand to match an elevation of a table of the portable tool;
wherein the vertical adjuster comprises a set of vertically oriented slots formed within at least one of the end walls, each vertically oriented slot adapted to receive a user-securable threaded fastener adapted to adjustably secure the mounting adapter to such at least one of the end walls;
wherein the at least one mounting device comprises at least one mounting device of a proprietary mounting system of the portable tool stand;
wherein the base member and the set of end walls are constructed from at least one rigid metallic material and the top member is constructed from a rigid non-metallic material;
wherein the at least one releasable lock comprises a user-operable friction lever adapted to frictionally constrain the top member and at least one end wall of the set of end walls in a fixed relationship;
wherein the at least one releasable lock comprises a diagonal brace having a first end pivotally mounted to one of the end walls and a second end slidably mounted within an elongated slot of the base member, and a brace-end lock configured to lock the second end at a user-selected position within the elongated slot;
wherein the set of end walls comprise a 90-degree orientation relative to the top member and the base member when the storage box is arranged in the at least one deployed position;
wherein the end walls includes a 90-degree positive stop to prevent the set of end walls from pivoting past the 90-degree orientation as the storage box is pivoted between the folded position and at least one deployed position;
wherein the top member has at least one hand opening to assist manual grasping of the storage box;
wherein the top member, the base member, and the set of end walls pivot about four pivotal axes that form an articulated parallelogram;
wherein the base member comprises a receiving slot configured receive a threaded shaft of the second supportive mount, the receiving slot adapted to enable transverse adjustment to the position of the storage box along an axis generally perpendicular to a longitudinal axis of the portable tool stand; and
wherein the base member comprises at least one drainage hole; and
wherein the top member has a width of about 20 inches and a length of about 32 inches.

18. The accessory device of claim 17, further comprising a set of instructions; and
wherein the accessory device is arranged as a kit.

19. A method of use related to an accessory support and storage device removably mountable on a portable tool stand, the method of use comprising the steps of:
providing a storage box configured to store user items adjacent a portable tool of the portable tool stand, the storage box including at least one mounting adapter configured to enable the interchangeable mounting of at least one mounting device functionally compatible with at least one proprietary mounting system of the portable tool stand;
providing at least one mounting device functionally compatible with at least one proprietary mounting system of the portable tool stand;
mounting the at least one mounting device to the storage box; and
mounting the storage box to the portable tool stand.

20. The method of use of claim 19, further comprising the step of configuring the storage box to be adjustable between a folded position and at least one deployed position, the at least one deployed position defining at least one storage space for the storage of user items.
